(19) United States
(12) Patent Application Publication
(10) Pub. No.: US 2015/0254078 A1
(43) Pub. Date: Sep. 10, 2015

(54) PRE-FETCH UNIT FOR MICROPROCESSORS USING WIDE, SLOW MEMORY

(71) Applicant: ANALOG DEVICES, INC., Norwood, MA (US)

(72) Inventors: Sudhir DESAI, Mansfield, MA (US); John A. Hayden, Sharon, MA (US)

(73) Assignee: ANALOG DEVICES, INC., Norwood, MA (US)

(21) Appl. No.: 14/201,477

(22) Filed: Mar. 7, 2014

(51) Int. Cl. G06F 9/38; G06F 9/30

(52) U.S. Cl. CPC G06F 9/3802; G06F 9/30145; G06F 9/3804

(57) ABSTRACT

In an example embodiment, a circuit is provided that includes a pre-fetch unit configured to pre-fetch instructions and data from a flash used by a microprocessor and decode the instructions and data without storing and accessing an address history, wherein the pre-fetcher is aware of the microprocessor's instruction set and performs parallel direct decode of each instruction accessed from the flash. In an example embodiment, method for pre-fetching instructions from a flash to a microprocessor is provided that includes reading a line of program code from the flash, assigning the instructions or data in the line to a thread in a hopper maintained in a cache, decoding the instructions to detect branches, and initiating a fetch from the flash if the target instruction is not found in one of the hoppers in the cache, building and maintaining predicted threads of instructions most likely to be executed by the microprocessor.

### TECHNICAL FIELD OF THE DISCLOSURE

The present disclosure relates generally to electrical circuits and, more particularly, to a method and apparatus for pre-fetching processor instructions from a wide, slow memory using a pre-fetch unit.

### BACKGROUND

Many microprocessors, such as Advanced Reduced Instruction Set Computing (RISC) Machine (ARM) processors, are used for special purpose applications and devices, such as embedded processors for consumer products, communications equipment, computer peripherals, video processors, etc. The devices are typically programmed by the manufacturer to accomplish their intended functions. The program or programs are generally loaded into read-only memory (ROM), which may be co-located or external to the processor. The read-only memory typically contains instructions (e.g., operations to perform certain intended functions) and data (e.g., parameters that remain constant). In the ARM architecture, in particular, the memory and external devices are typically accessed via one or more high-speed buses.

For various reasons (e.g., to allow the manufacturer to correct defects in the program; to provide new features or functions to existing devices; to allow updating the data or parameters), the read-only memory is often configured to be re-programmable. A relatively slower memory (e.g., compared to processor internal memory) with a wide interface, such as dynamic random access memory (DRAM), double data rate (DDR) memory, and flash memory can be a common choice for re-programmable read-only memory. In the flash memory, the contents are permanent and unchangeable, except when a particular set of signals is applied (when the appropriate set of signals is applied, revisions to the program may be downloaded, or revisions to the data or parameters may be made). However, the time required to access programs or data in a flash memory is generally substantially longer than the time required to access other storage devices, such as registers, latches or static random access memory (SRAM) arrays. If the ARM processor executes program instructions directly from the flash memory, the access time can limit the speed achievable by the processor. Because ARM-based microcontrollers are commonly used for high performance applications, or time critical applications, timing predictability is often an essential characteristic of the device.

In an existing mechanism for enhancing memory access time, a memory accelerator module buffers program instructions and/or data for high speed access using a deterministic access protocol. The program memory is logically partitioned into ‘cyclically sequential’ partitions, and the memory accelerator module includes a latch associated with each partition. When a particular partition is accessed, it is loaded into its corresponding latch, and the instructions in the next sequential partition are automatically pre-fetched into their corresponding latch. Thus, the performance of a sequential-access process can have a known response, because the pre-fetched instructions from the next partition will be in the latch when the program sequences to these instructions.

Previously accessed blocks remain in their corresponding latches until the pre-fetch process ‘cycles around’ and overwrites the contents of each sequentially-accessed latch. Thus, the performance of a loop process, with regard to memory access, can be determined based solely on the size of the loop. If the loop is below a given size, it can be executable without overwriting existing latches, and therefore will not incur memory access delays as it repeatedly executes instructions contained within the latches. If the loop is above a given size, it can overwrite existing latches containing portions of the loop, and therefore require subsequent re-loadings of the latch with each loop. An additional access mode also forces a read from the memory whenever a non-sequential sequence of program instructions is encountered. However, in the alternative access mode, the execution of a branch instruction necessarily invokes a memory access delay.

In another existing mechanism, instruction pre-fetching may be controlled by a pre-fetch scheme, which determines the order in which pre-fetching of instructions occurs. For example, the instruction pre-fetch order may occur in the program order or may be part of a branch prediction where the processor, using only the known address of the current instruction, tries to predict the instruction that will most likely be requested next. When an instruction pre-fetch completes, the pre-fetched instruction is not stored in a buffer until a fetch request by the processor for a previous instruction pre-fetch of the same instruction stream as the current instruction pre-fetch is fulfilled. Thus, the memory simply continues to provide the last instruction requested until other instruction (or data) is requested.

In yet another mechanism, a processor is configured to receive a pre-fetch instruction, which specifies a memory address in a memory from which to retrieve data. After receiving an instance of a pre-fetch instruction, the processor may retrieve data from the specified memory address and store the data in a data cache, irrespective of whether data corresponding to the specified memory address is already stored in the data cache. The processor may implement a variety of pre-fetch mechanisms, alone or in combination, to determine what data to pre-fetch. One example is an automated pre-fetch scheme, such as a branch prediction algorithm or a pattern-based pre-fetch engine. In another example, the processor may use cache lines to buffer the data before it will be used, or the processor may use a dedicated pre-fetch buffer. Note that traditional branch predictors rely on remembering past experience of branches observed. On the other hand, caches retain as much recently accessed code as limited capacity permits.

In substantially all existing mechanisms, address history is stored to look for a previous pattern of branch taken (or not taken) at an address being currently executed. The history is typically created by the processor notifying the pre-fetcher of taking a branch (on or after the fact); thus the pre-fetcher is dependent on the processor to perform the branch decode.

### OVERVIEW

The present disclosure relates generally to a pre-fetch unit for a microprocessor using a relatively wider slower memory (e.g., flash memory) compared to the microprocessor's internal memory. In an example embodiment, a circuit is provided that includes a pre-fetch unit configured to pre-fetch instructions and data from a flash used by a microprocessor and decode the instructions and data without storing and accessing an address history, where the pre-fetcher is aware of the microprocessor's instruction set (e.g., a list of all the instructions with all their variations, that a processor can execute; includes arithmetic such as add and subtract, logic instructions such as and, or, and not, data instructions such as move, input, output, load, and store, and control flow instructions such as goto, if . . . goto, call, and return) and performs parallel direct decode of each instruction accessed from the flash before the microprocessor receives the instruction. In an example embodiment, method for pre-fetching instructions from a flash to a microprocessor is provided that includes reading a line of program code from the flash, assigning the instructions or data in the line to a thread in a hopper maintained in a cache, decoding the instructions to detect branches, and initiating a fetch from the flash if the target instruction is not found in one of the hoppers in the cache, building and maintaining predicted threads of instructions most likely to be executed by the microprocessor.

### BRIEF DESCRIPTION OF THE DRAWINGS

FIG. 1 is a simplified block diagram illustrating an example schematic of a system comprising a flash pre-fetch unit;

FIG. 2 is a simplified block diagram illustrating example details of an embodiment of the system;

FIG. 3 is a simplified block diagram illustrating other example details of an embodiment of the system;

FIG. 4 is a simplified bock diagram illustrating yet other example details of an embodiment of the system;

FIG. 5 is a simplified block diagram illustrating yet other example details of an embodiment of the system;

FIG. 6 is a simplified block diagram illustrating yet other example details of an embodiment of the system;

FIG. 7 is a simplified block diagram illustrating yet other example details of an embodiment of the system;

FIG. 8 is a simplified block diagram illustrating yet other example details of an embodiment of the system;

FIG. 9 is a simplified block diagram illustrating yet other example details of an embodiment of the system;

FIG. 10 is a simplified block diagram illustrating yet other example details of an embodiment of the system;

FIG. 11 is a simplified block diagram illustrating yet other example details of an embodiment of the system;

FIG. 12 is a simplified block diagram illustrating yet other example details of an embodiment of the system;

FIG. 13 is a simplified flow diagram illustrating example operations that may be associated with an embodiment of the system;

FIG. 14 is a simplified flow diagram illustrating other example operations that may be associated with an embodiment of the system;

FIG. 15 is a simplified flow diagram illustrating yet other example operations that may be associated with an embodiment of the system;

FIG. 16 is a simplified flow diagram illustrating yet other example operations that may be associated with an embodiment of the system; and

FIG. 17 is a simplified flow diagram illustrating yet other example operations that may be associated with an embodiment of the system.

### DESCRIPTION OF EXAMPLE EMBODIMENTS OF THE DISCLOSURE

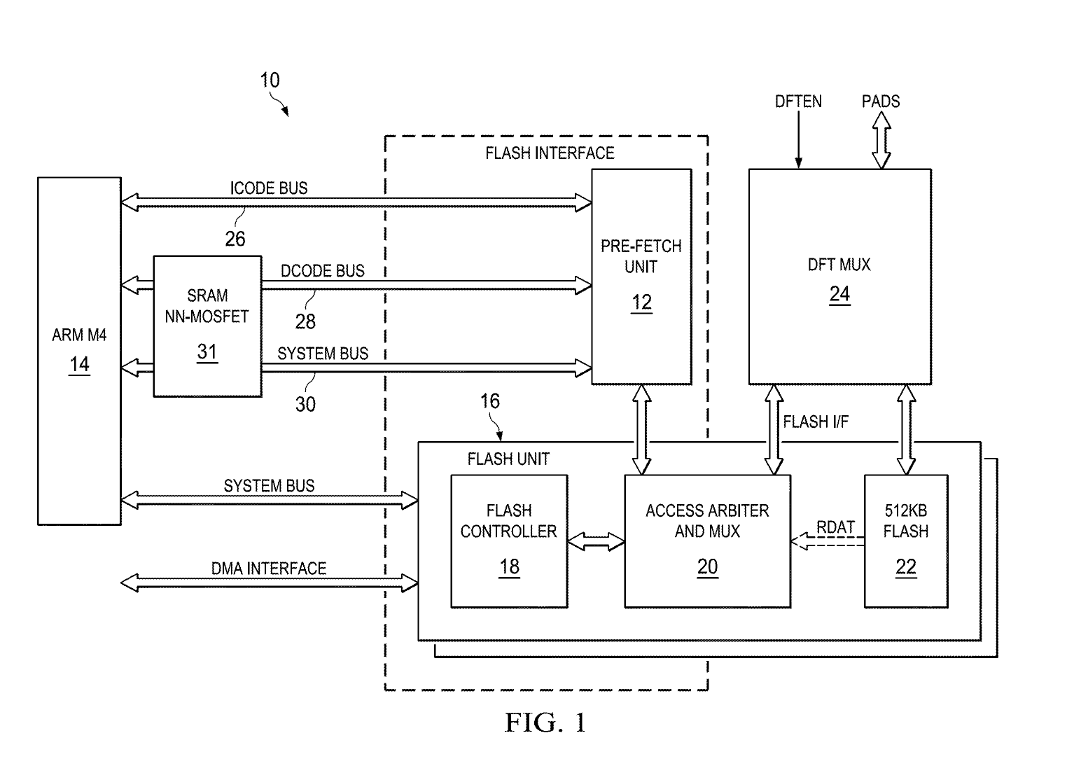

FIG. 1 is a simplified block diagram illustrating a system 10 comprising a pre-fetch unit 12 that interfaces between an ARM processor 14 and a flash unit 16. Note that although the example embodiments described herein refer to the ARM processor type and a flash memory type, the descriptions and operations disclosed herein are applicable to any microprocessor that uses a wide slow external memory. Accordingly, as used herein, the term “flash” is meant to encompass any wide, slow, parallel memory that may be external or internal (e.g., embedded) to a microprocessor (e.g., that is wider and slower than the microprocessor's cache memory), and includes traditional flash memory as well as DRAMs, magnetoresistive random-access memory (MRAM), DDRs, and SRAMs. The term “microprocessor” refers to a multipurpose, programmable device that accepts digital data (e.g., binary numbers) as input, processes it according to instructions stored in a memory (e.g., internal memory or external memory, such as flash), and provides results (e.g., binary numbers) as output, for example, using sequential digital logic. Examples of the microprocessor include ARM processor 14, and digital signal processors (DSPs).

In various embodiments, pre-fetch unit 12 can include an eight line cache, a branch decoder and control structures which store and maintain a pre-fetcher state. Flash unit 16 can include a flash controller 18, an access arbiter and multiplexer (mux) 20 and a flash (memory) 22. Flash controller 18 may be responsible for erase and program operations on flash 22; access arbiter and mux 20 may facilitate arbitrating accesses to and from multiple buses to flash 22. A design for test (DFT) mux 24 may be located between the chip pads and flash unit 16. An ICODE bus 26 may facilitate fetching instructions between ARM processor 14 and pre-fetch unit 12. A DCODE bus 28 may facilitate fetching data (e.g., parameters) between ARM processor 14 and pre-fetch unit 12. A system bus 30 may facilitate snooping a stack (e.g., stored in an appropriate SRAM NN-MOSFET 31 (e.g., data SRAM)) in ARM processor 14 if necessary. Note that the term “stack” includes any suitable internal memory of ARM processor 14, including lookup tables and vector tables in internal memory.

For purposes of illustrating the techniques of system 10, it is important to understand the operations of ARM processor 14. The following foundational information may be viewed as a basis from which the present disclosure may be properly explained. Such information is offered earnestly for purposes of explanation only and, accordingly, should not be construed in any way to limit the broad scope of the present disclosure and its potential applications.

In a general sense, ARM processor 14 may provide for several registers, including a stack pointer (SP), a link register (LR) and a program counter (PC) for executing instructions. The instructions are generally sequentially executed, except when a branch instruction is encountered. The branch instruction (also called a jump) is a break in the sequential flow of instructions that ARM processor 14 is executing; the branch instruction can also cause a break in a sequential access of code space in flash 22. A relative branch is one where the target address is calculated based on the value of the current PC. (The relative branch is referred to as having PC-relative addressing. PC-relative with immediate offset addressing refers to adding or subtracting the value of an immediate offset to or from the value of the base register (PC), where the immediate offset is encoded in bits within the machine instruction). An absolute branch jumps to an address specified in the branch instruction, regardless of the current PC. Absolute branches are used, for example, when the address of the target is provided as a function pointer.

ARM processor 14 commonly uses the following types of branch instructions: B (simple relative branch); BX (absolute branch specifying an address in a particular register); BL (relative branch with link to the LR); BLX (relative branch with link and exchange to the LR; can also include an absolute branch if the address is specified in the instruction); POP{ . . . ,PC} (absolute branch used as a common return sequence in cases where LR has been pushed onto the stack at the start of the function); LDR PC (absolute branch indicating a load from a literal pool directly into PC). Branch instructions with an L suffix (e.g., BL and BLX) store a return address in LR.

Branch instructions can be associated with the stack (e.g., short-term large scale memory element (e.g., random access memory (RAM)) of ARM processor 14. In a general sense, the stack is used for several purposes, including keeping track of the point to which each active subroutine returns control when it finishes executing. The return address (e.g., address following the call instruction) is pushed onto the stack with each subroutine call. When the BL or BLX instruction performs a subroutine call, the LR value is set to the subroutine return address. To perform a subroutine return, the LR value is copied back to the PC. On a subroutine entry, the LR is stored to the stack with an instruction of the form: PUSH { . . . ,LR} and a matching instruction to return of the form: POP { . . . ,PC} is used.

Additional special purpose branches, such as compare, branch on non-zero (CBNZ) and compare, branch on zero (CBZ) instructions are useful for short-range forward branches, such as loop terminations, that would otherwise require two or more instructions. LDR PC loads data from literal pools (e.g., memory spaces to hold certain constant values that are to be loaded into registers). In typical cases, the literal pools are placed in locations where ARM processor 14 would not attempt to execute them as instructions. For example, literal pools can be placed after unconditional branch instructions, or after return instruction at the end of a subroutine. In particular embodiments, ARM processor 14 may use Table Branch Byte (TBB) and Table Branch Halfword (TBH), which may be useful for implementation of jump tables. One argument register is a base pointer to a table, and the second argument is an index into the table. The value loaded from the table is then doubled and added to the PC. Processors (including various versions of ARM processors) can implement other branch instructions, such as hardware loop start/end, and jump double indirect via memory.

Turning back to system 10, the impact on cycle performance of ARM processor 14 due to a slower flash memory can be reduced by using a wide flash (e.g., 128 bits), and/or a small cache and a pre-fetch unit to fill the cache in some embodiments. Pre-fetch unit 12 can fetch a wide line from flash 22 and, before ARM processor 14 ever sees the fetches, pre-fetch unit 12 may decode all possible instruction footprints in the line to detect both instruction-fetch branches and data-literal loads (e.g., anything that can change a sequential order of accesses to code space in flash 22). In various embodiments, pre-fetch unit 12 may decode instructions and data without storing and accessing an address history (e.g., by directly decoding what is read from flash 22). In some embodiments, a branch decoder acting on already fetched instructions may aid pre-fetch unit 12 in reading the flash locations most likely to be accessed by ARM processor 14. In addition to branches, ARM processor 14's literal loads may be detected and fetched in advance.

In some embodiments, the pre-fetch unit 12's decode and decision logic may be applied to a line of flash data (a) in some clock cycle before the instruction is presented to ARM processor 14, (b) in the same clock cycle as the instruction is presented to ARM processor 14, or (c) after the instruction fetch may have been presented to ARM processor 14 in the past but the instruction is still in pre-fetch unit 12's hoppers and is re-examined by pre-fetch unit 12.

In some embodiments wherein call and/or return to leaf routines (e.g., routines that do not call other routines) do not expose the return address by pushing onto the stack (in other words, the routines do not use the stack), pre-fetch unit 12 can identify instructions that set the return-pointer register (e.g., link register (LR)), recall a most recent LR value, detect return instructions (e.g., branch via LR), and predict the branch target. In some embodiments, decoding general call/returns that use the stack in ARM processor 14 may be accelerated by detecting POP-PC instructions, and snooping system bus 30 for loads from the stack to the PC. Pre-fetch unit 12 can accelerate the flash lookup based on the observed POP-PC value before ARM processor 14 presents the fetch to the new PC.

In some embodiments wherein ARM processor 14 supports hardware loop setup instructions, with a PC-relative offset to a start and/or end of a loop body and/or a loop count value being declared in the loop setup instructions, and/or a register (e.g. loop count register (LC)) maintaining a count of loop repeats to be executed, pre-fetch unit 12 can identify the loop setup instructions, and/or recall and decrement the LC, and/or predict ARM processor 14's automated branching associated with a loop hardware, which may include branching from the end to the start of the loop and/or branching from before the start of the loop to after the end of the loop for zero-length loops.

Pre-fetch unit 12 may use control structures to build thread information. A “thread” as used herein comprises a set of instructions executed sequentially. Pre-fetch unit 12 may develop thread tracking methods, for example, to facilitate make fetching decisions that further reduce the performance impact of a slow flash memory access. In some embodiments, a modified LRU scheme may be used to select cache-lines to store instructions and literals (data, parameters) belonging to threads or literals not belonging to a tracked thread.

In some embodiments, a programmable (e.g., tunable) set of controls which the programmer can modify as appropriate may be used to decode instructions and pre-fetch instructions and literals. Changes in flash wait states (e.g., flash-to-core clock ratio) and in other latencies in system 10 may be accommodated, for example, by engaging or disabling elements of the pre-fetch acceleration for optimum performance.

Unlike a traditional branch predictor which caches branch probabilities at a given line (e.g., ‘strongly not taken,’ etc.), embodiments of system 10 may directly decode the instruction operation codes (opcodes) as they are retrieved from flash 22, and make preparations for taking the detected branches. Thus branches may be anticipated earlier on a first visit to the memory address (e.g., location); branches need not be anticipated based on any prior observations or recordation of the processor's past visit to the location. Embodiments of system 10 may be largely free of execution speed differences between first and second passes (e.g., cold cache vs warm cache); each pass may be equally fast. In some embodiments, the opcode data that was fetched may be recorded in a small cache structure; thus, execution differences may not be completely eliminated.

Unlike a traditional branch predictor, performance according to embodiments of system 10 may not be dependent on a capacity of the cache to remember past branches or on a probability-of-hit due to set, way and tagging schemes. Pre-fetch unit 12 may make preparations to branch only on opcodes actually observed. Hence, the methods according to various embodiments can scale without limit on a size of the code space being accelerated.

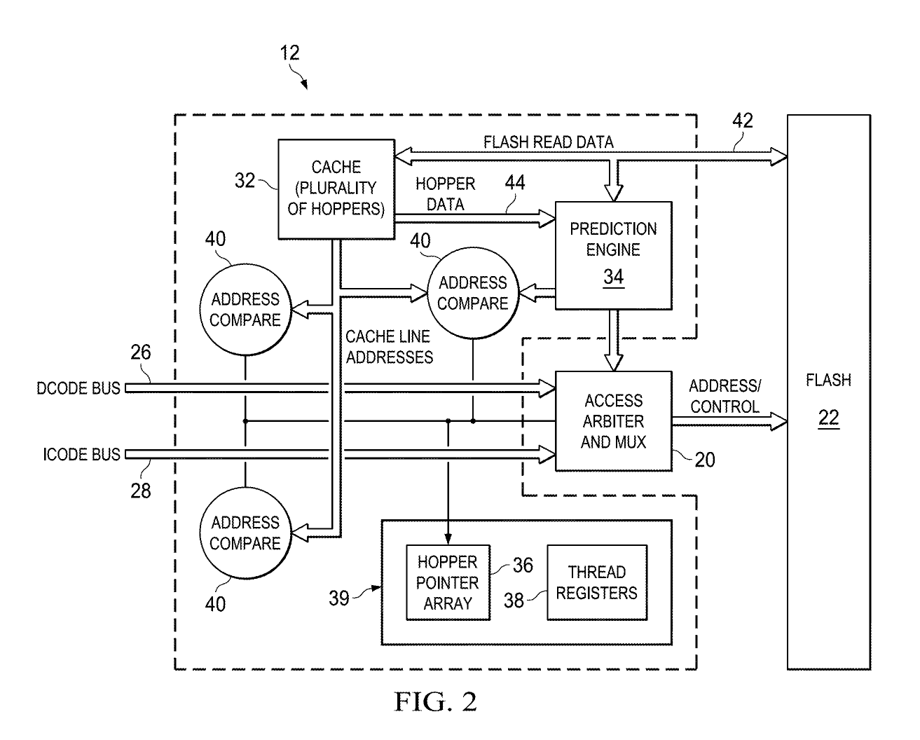

Turning to FIG. 2, FIG. 2 is a simplified block diagram illustrating example details of pre-fetch unit 12 according to another embodiment of system 10. Example pre-fetch unit 12 may comprise a cache 32, a prediction engine 34, a hopper pointer array 36, thread registers 38 (hopper pointer array 36 and thread registers 38 comprise control structures 39) and address compare modules 40. In some embodiments, cache 32 may comprise data separated into groups of eight lines each (each line being called a hopper), comprising a plurality of hoppers. Data 42 may be pre-fetched from flash 22. Hopper data 44 may be decoded by prediction engine 34 and fed to access arbiter and mux 20.

During operation, cache 32 is reset initially. Flash 22 may be accessed for flash read data 42. Prediction engine 34 may decode flash read data 42 as it is accessed and detect non-sequential operations, such as branches and literal loads. Based on the detection, flash 22 may be further accessed for appropriate instructions and data as detected and/or predicted by prediction engine 34, and cache 32 may be populated accordingly. Meanwhile, hopper pointer array 36 and thread registers 38 comprising control structures 39 may monitor flash read data 42 and assign the instructions and data to appropriate threads in cache 32.

Flash read data 42 may be stored in a specific hopper (e.g., selected using LRU scheme in some embodiments) ahead of accesses to the instruction or data by ARM processor 14. An appropriate word may be returned on request from cache 32 to ARM processor 14. In case of instruction fetches, data residing in cache 32 can be used to service the next few ARM Advanced Microcontroller Bus Architecture (AMBA) High-performance Bus (AHB) accesses. The resulting free cycles can be used to fetch additional flash lines as instructed by the branch detector in prediction engine 34. Pre-fetcher unit 12 can get more free cycles when ARM processor 14 stalls. Substantially every access to flash 22 by ARM processor 14 appearing on ICODE bus 26 or DCODE bus 28 is intercepted by address compare modules 40. Address compare modules 40 may compare the address requests to information stored in threads in cache 32. In case of a hit, the instruction or data is returned from cache 32 as hopper data 44. In case of a miss, an access is made to flash 22, incurring cycle penalties equal to the wait states of flash 22.

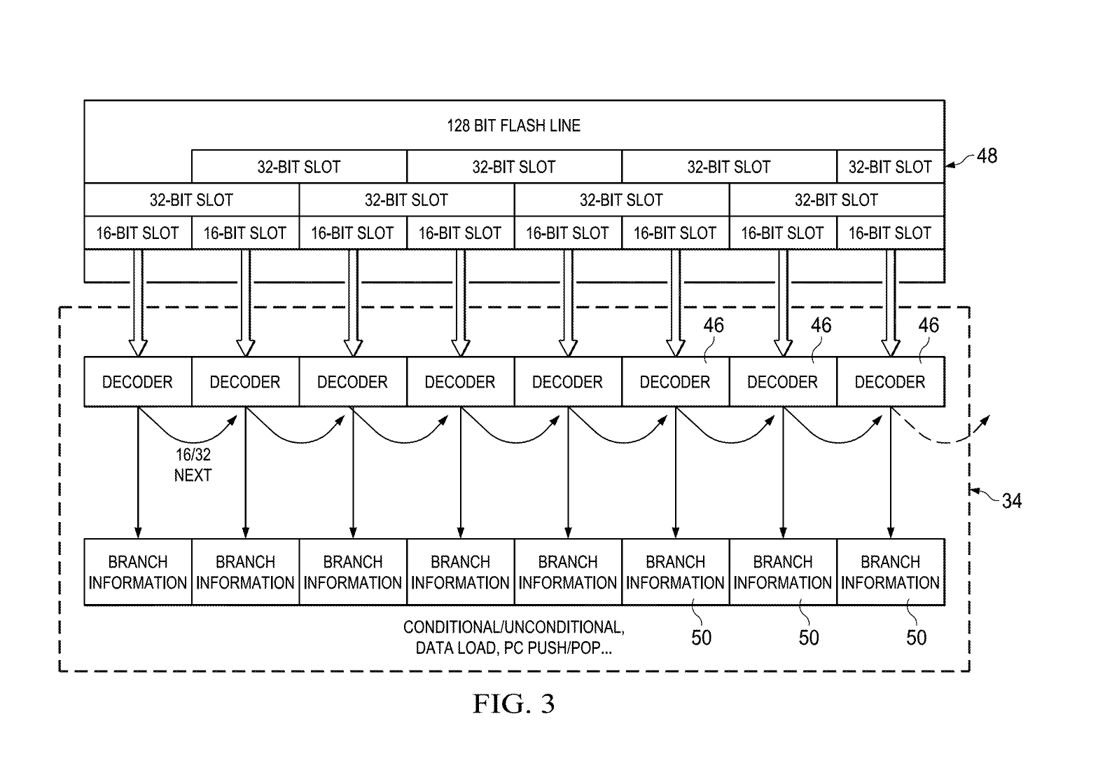

Turning to FIG. 3, FIG. 3 is a simplified block diagram illustrating example details of an embodiment of system 10. Assume, merely for teaching purposes, and not as a limitation, that flash 22 is M times slower than ARM processor 14. To compensate, flash 22 can be organized to be N times wider than the processor's instruction bus, where N>M. ARM processor 14 can potentially run full speed, but branches and data fetches in the code may seriously degrade performance. In various embodiments, pre-fetch unit 12 may be constructed to be aware of the target processor's instruction set, and perform parallel direct decode of each candidate instruction as each N-instruction wide data line emerges from flash 22. Pre-fetch unit 12 can make correct decisions about a probable execution flow of ARM processor 14 before ARM processor 14 even receives the instructions to be executed.

According to various embodiments, prediction engine 34 in pre-fetch unit 12 may include a plurality of decoders 46. During operation, a 128 bit flash line 48 may be divided into 16 bit slots and processed sequentially by corresponding decoders 46 to generate branch information (info) 50 for each of the 16 bit slots. Each branch info 50 may describe various branching options, such as conditional branching, unconditional branching, data load, PC push/pop, etc. In various embodiments, decoders 46 may be also capable of interpreting variable-width instructions, even if there is ambiguity as to the starting alignment of the execution path. In various embodiments, decoders 46 may interpret 32-bit instructions that span an end boundary of flash line 48 by speculatively and partially decoding one half of the instruction present in a specific flash line 48, and communicating with a first one of 16-bit decoders 46 in another flash line 48 to complete the decode of the full 32-bit instruction.

In some embodiments, the following types of relative branches (e.g., having PC-relative with immediate offset addressing) and branches with indirect addressing may be decoded and accelerated. In relative branches (e.g., having PC-relative with immediate offset addressing), the effective address for a PC-relative instruction address is an offset parameter added to the address of the next instruction; generally certain branch instructions are PC-relative with immediate offset; examples include B.T1, B.T2, B.T3 and B.T4; branch with link (immediate)(BL); compare and branch on zero (CBZ), compare and branch on non-zero (CBNZ); load a register (LDR) (e.g., load literal to PC). In branches with indirect addressing, the branch address may indicate a register entry or a memory load. For example, branch with exchange (BX) can be accelerated by modeling the LR register. When the branch detector detects a BL or a branch with link and exchange (BLX), the modeled LR register in pre-fetch unit 12 may be updated. The address in the modeled LR register may be used to pre-fetch the target of return instruction when a BX return instruction is detected by the branch detector. Other examples of branches with indirect addressing include: pop multiple registers including PC (e.g., POP.T1, POP.T2 and POP.T3); load multiple registers including PC (e.g., LDM, LDMDB and LDMEA); and load literal to PC.

When the branch detector detects any instruction that loads to the PC (such as any of the POP*, LDM* or load literal instructions), the branch detector may snoop system bus 30 for a burst read associated with the instructions. In a given target processor architecture, the load order of registers in a burst read is deterministic; thus the position in the burst sequence of the data to be loaded into the PC is substantially always predictable. In the instance of ARM Mx processors, the last read data may be substantially always loaded into the PC, which is effectively a branch to that address. (In a general sense, the PC is incremented by the size (which is typically four bytes in ARM processors) of the instruction executed. Branch instructions load the destination address into PC. Data operation instructions may also load the PC directly.) The read data may be used to pre-fetch before the actual branch occurs in the next cycle. In some embodiments, an alternate way to accelerate the branches may be to use a return stack.

In some embodiments, following types of data loads may be detected and pre-fetched: Literal Load instructions: LDR, LDRB, LDRH, LDRSB, LDRSH and LDRD instructions (e.g., certain instructions that use PC relative addressing mode with immediate offset); and VLDR: floating point load registers (e.g., certain other instructions that use PC relative addressing mode with immediate offset).

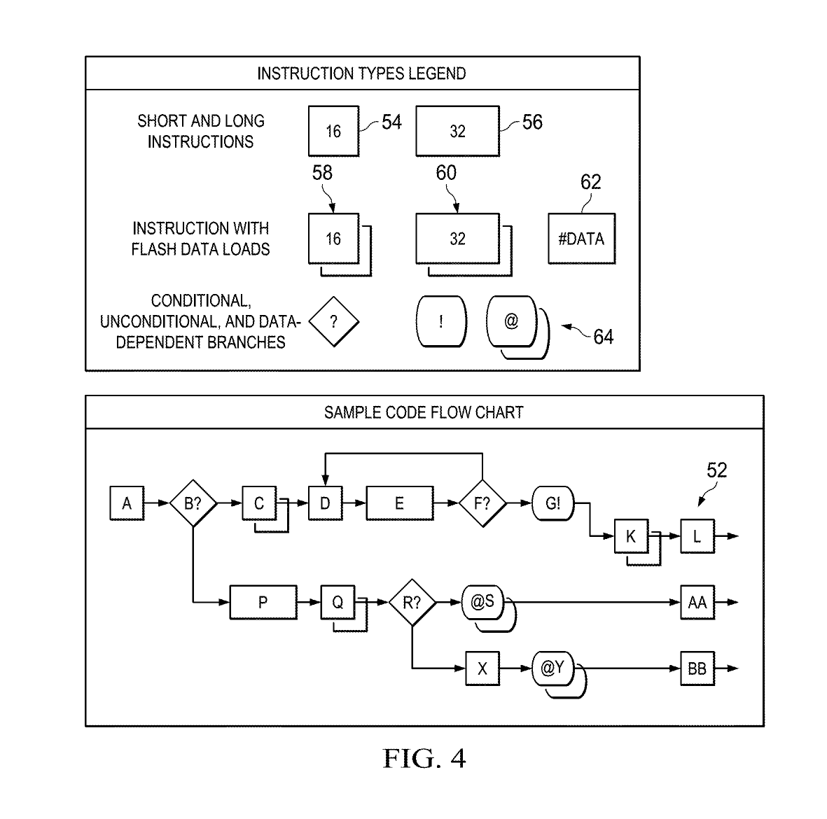

Turning to FIG. 4, FIG. 4 is a simplified block diagram illustrating details of an example code 52 that may be associated with an embodiment of system 10. Example code 52 may include 16 bit long instructions 54, 32 bit long instructions 56, 16 bit instructions 58 with flash data loads, 32 bit instructions 60 with flash data loads, data 62, and branches 64 (e.g., conditional, unconditional, data dependent). Some instructions (e.g., 54, 56) may have no effect on program flow, while others (e.g., 64) encode conditional or unconditional branches which can disrupt an otherwise linear sequence of flash memory accesses. Further, other instructions (e.g., 58, 60, 62) may encode data accesses which read from constants stored nearby in flash 22 (such instructions can frequently occur when the program refers to constant numbers or address pointers). The flash data loads (e.g., 58, 60, 62) also compete with instruction fetches (e.g., 54, 56) for access to flash 22, and can significantly degrade performance. Some instructions (e.g., 58, 60) can require additional look-aside memory accesses for loading data. Because flash accesses are probably N times slower than program fetches, it can be important to anticipate branches and immediate-data accesses. When the program is compiled, the resulting machine instructions are packed into flash 22 with little regard for impact on performance of potential memory systems. In various embodiments, pre-fetch unit 12 can implement instruction decoders 46 for a limited set of most-commonly-used instructions, which comprise a bulk of the branch and data-load activity in typical benchmarked programs.

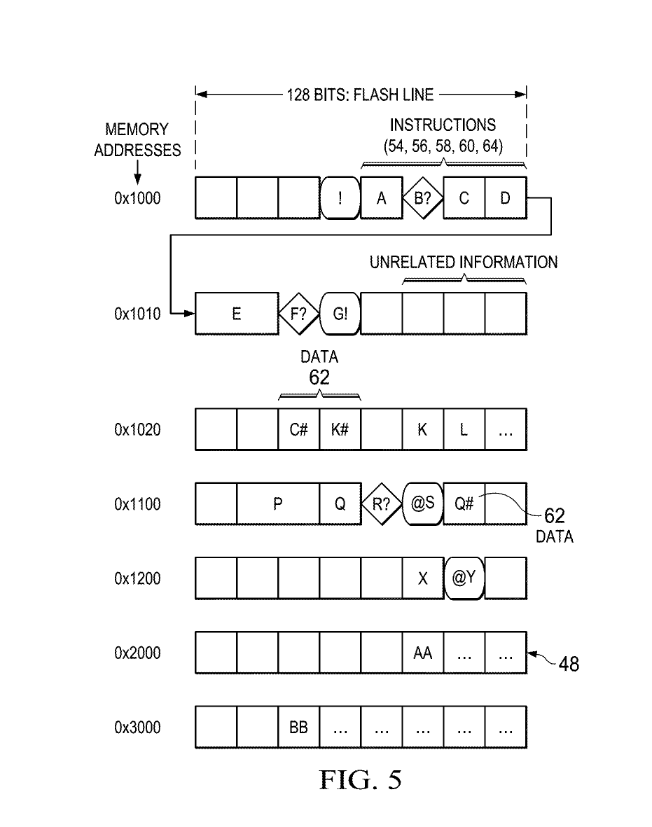

Turning to FIG. 5, FIG. 5 is a simplified block diagram illustrating details of example code 52 that may be associated with an embodiment of system 10. Instructions 54, 56, 58, 60, 64 representing example code 52 is indicated packed into flash memory, where 16- and 32-bit instructions 54-60 are fitted into 128-bit-wide flash memory lines 48. Instructions and data 62 may be interleaved with other unrelated memory locations. Simple, linear execution sequences that continue from an end of one line to a beginning of the next (e.g., as indicated by the arrow) may be rare, and may be the exception rather than the rule in many scenarios.

In some embodiments, a width locking scheme may be utilized to locate valid instructions in the flash data (e.g., for 32 bit wide ARM fetches). Raw instruction widths can be calculated for each 16-bit half-word. During operation, the first half-word with a raw width of 16 is initially located. The half-word can be a 16-bit instruction or a second half-word of a 32-bit instruction. The next half-word may mark a beginning of a valid instruction. Once locked, the locked status may be carried forward to next sequential flash line 48.

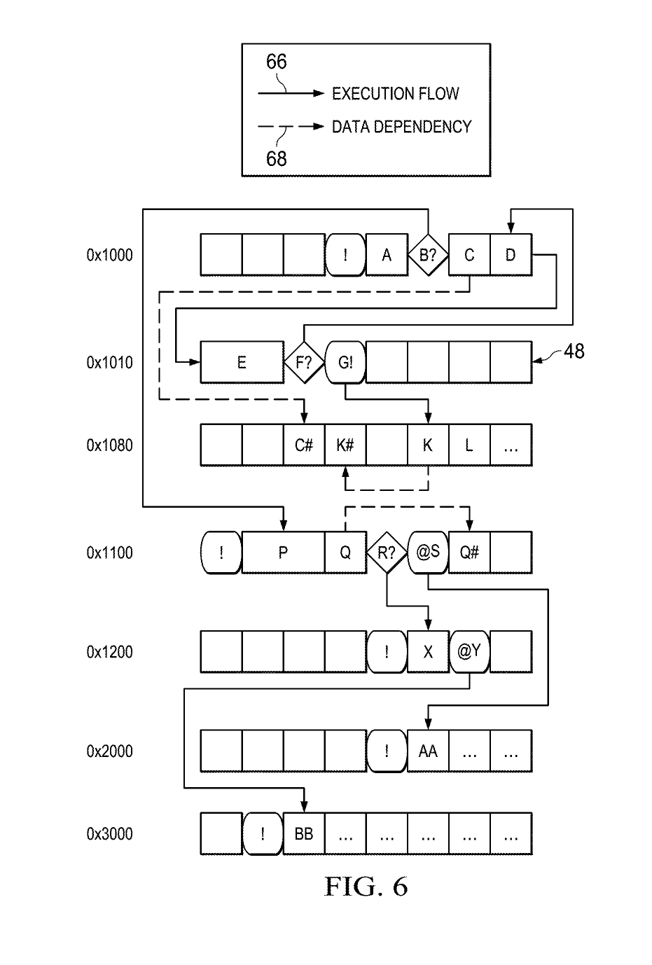

Turning to FIG. 6, FIG. 6 is a simplified block diagram illustrating details of example code 52 that may be associated with an embodiment of system 10. Arrows 66 and 68 indicate execution flow and data dependency, respectively, of 128 bit flash lines 48. Data dependencies indicate where flash 22 must perform a look-aside access to retrieve a data value before continuing with further code fetches. An actual sequence of the program may include paths from and to various memory addresses in flash 22 in no particular order. For example, during execution, example code 52 may indicate a program flow from instruction A to conditional branch B at memory address 0x1000, followed by a jump to P at memory address 0x1100. Instruction C at memory address 0x1000 may need a data look-up of C# at memory address 0x1080; and so on. According to various embodiments, pre-fetch unit 12 can anticipate the possible pathways so that flash memory accesses can be started in advance to prepare for future instruction or data fetches.

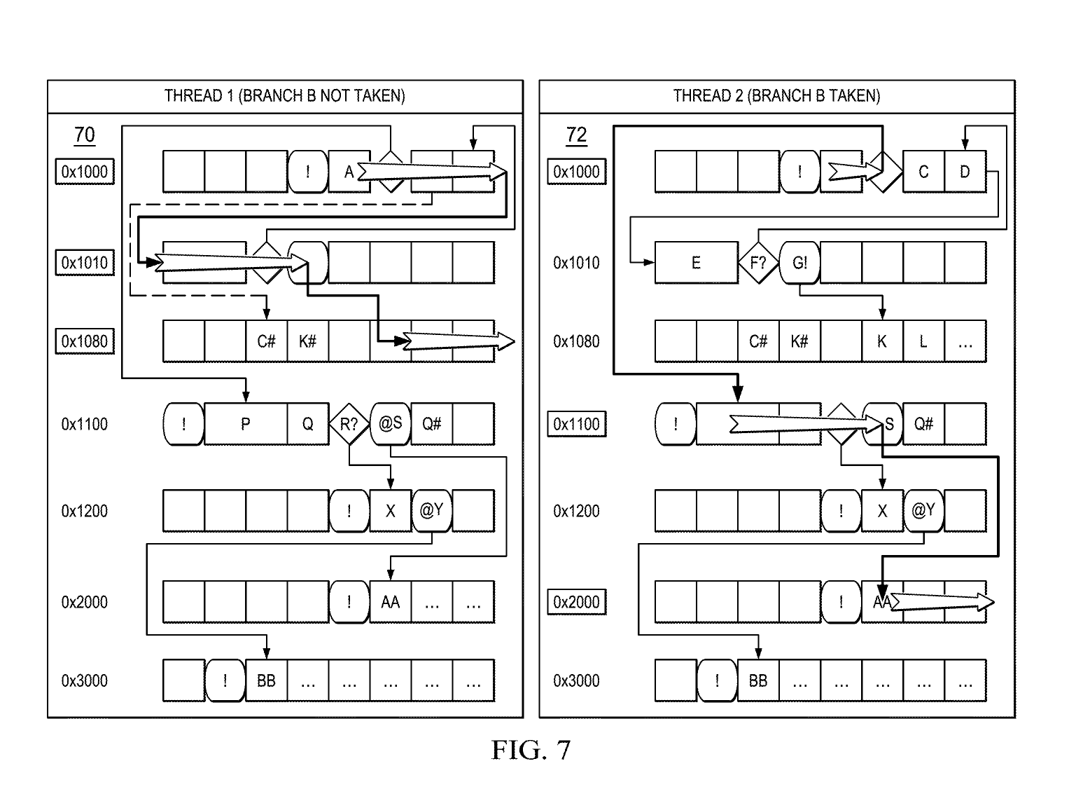

Turning to FIG. 7, FIG. 7 is a simplified block diagram illustrating details of example code 52 that may be associated with an embodiment of system 10. Example code 52 may include conditional branches that describe alternate pathways for the execution. The conditional branches may depend on information hidden within (e.g. in data registers) ARM processor 14 and are thus not possible for pre-fetch unit 12 to determine from outside ARM processor 14. For example, thread 70 indicates a pathway wherein a branch at B was not taken. The instruction path includes accessing memory addresses 0x1000, 0x1010 and 0x1080 (in that order). Thread 72 indicates an alternate pathway wherein the branch at B was taken. The instruction path includes accessing memory addresses 0x1000, 0x1100 and 0x2000 (in that order).

The instructions stored in cache 32 may be viewed as a part of an instruction thread. The instruction thread comprises instructions to be executed sequentially. Any branch instruction initiates a new thread and the branch instruction is treated as a last instruction in the current thread. The instruction at the branch target address is considered the first instruction in the new thread. A thread may have at least two instructions after the branch (e.g., ARM processor 14 may fetch up to 2 more words after the word containing the taken branch to feed a 3 word deep instruction buffer). Depending on a location of the branch in cache 32, pre-fetcher unit 12 may initiate an additional flash read to cater to such ARM pre-fetches. The additional access may be referred herein as a “trailer.” The trailer follows the branch instruction at the end of a thread and represents ARM processor 14's pre-fetch which may run on past the branch. In various embodiments, detected and pre-fetched literal loads can be considered part of the instruction thread for easier tracking whereas undetected loads can be considered stand-alone accesses not belonging to any thread.

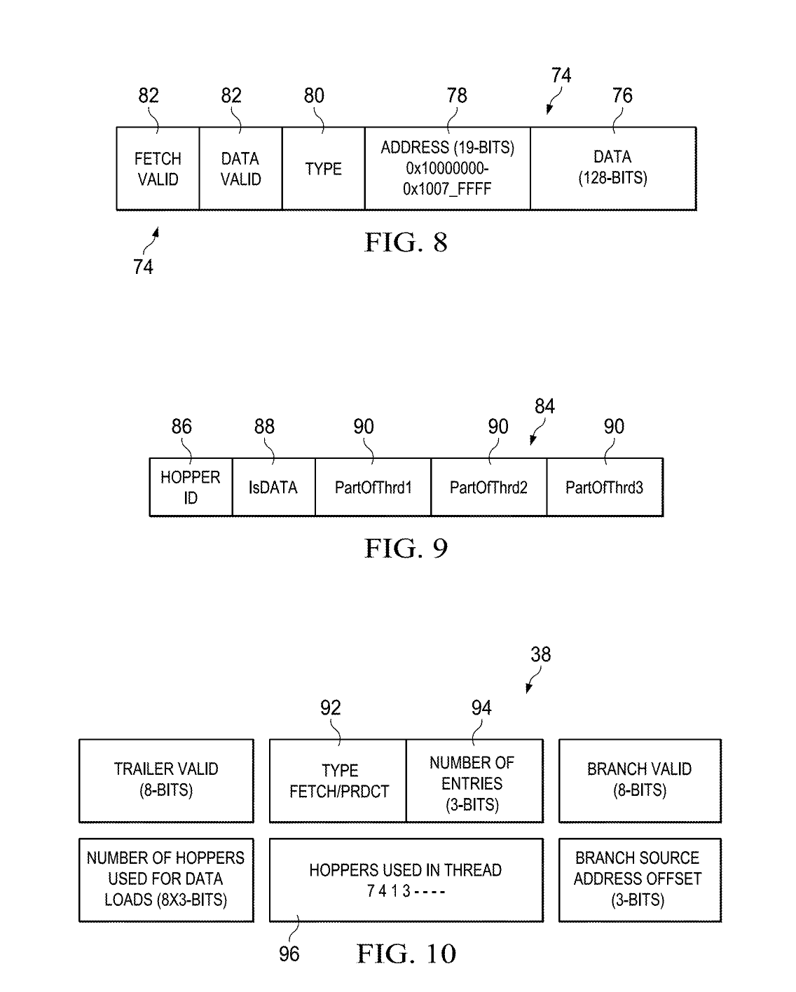

Turning to FIG. 8, FIG. 8 is a simplified block diagram illustrating details of an example line 74 in cache hopper 32 according to an embodiment of system 10. According to the embodiment, each line 74 (also called hopper 74) in cache 32 can hold 128-bits of data 76, which is equivalent to the flash read data size. Hopper 74 can also store a fetch address 78 corresponding to data 76, a lower 4-bits of which point to byte, half-word or a word accessed by ARM processor 14 or to branch info 48 decoded by decoder 46. Each hopper 74 may also store type bit 80, and status bits 82 (e.g., Fetch Valid and Data Valid) representing whether a fetch is in progress or it (already) holds valid data. Type bit 80 can specify whether data 76 was acquired a result of a code fetch or a data fetch. Each hopper 74 may be referenced by an identifier (ID) which can range in some embodiments from 0 to 7. Each hopper 74 may retain its data as far as possible (e.g., until being pushed out of cache by Least Recently Used (LRU) scheme, or when pre-fetch unit 12 causes loss of data due to an intentional command). Each hopper 74 may be invalidated when it is used for new code or data access and when flash controller 18 instructs pre-fetch unit 12 to do so in certain situations (e.g., re-programming flash 22).

Each decoder 46 may include a branch detector that decodes the code residing in cache 32 to detect branches, determine the target address and initiate a fetch if the target code is not already residing in hopper 74. As a smallest ARM instruction can be 16-bits wide and the hopper width is 128-bits, 8 decode units capable of decoding a half-word can be employed to cover the entire hopper width. Each decoder 46 may operate on 16-bits of code and is capable of decoding a 16-bit instruction or half of a 32-bit instruction. As a single hopper caters to multiple (e.g., 4) ARM fetches, the branch detection may be performed on code corresponding to the ARM fetch address and subsequent sequential addresses.

Turning to FIG. 9, FIG. 9 is a simplified block diagram illustrating details of an example pointer unit 84 in hopper pointer array 36 according to an embodiment of system 10. In some embodiments, pre-fetch unit 12 may employ a LRU scheme to select hopper 74 for the next flash read. Employing the LRU scheme can increase likelihood of hoppers containing instructions fetched by ARM processor 14 in the near future, especially in case of small loops. In such embodiments, hopper pointer array 36 can comprise hopper IDs sorted by their LRU status. Each pointer unit 84 can include a hopper ID field 86, an access nature field 88 (e.g., information regarding a nature of the access such as instruction access or data access) and thread identification field 90 (e.g., whether the hopper contents belong to a particular thread).

Turning to FIG. 10, FIG. 10 is a simplified block diagram illustrating details of an example thread register 38 according to an embodiment of system 10. Thread register 38 may comprise information about the threads predicted by prediction engine 34 and stored in cache 32. Threads (e.g., 70, 72) may be categorized into two types (e.g., for easier tracking): a fetch thread; and a prediction thread. The fetch thread indicates a thread from which ARM processor 14 is fetching instructions and the prediction thread indicates a thread created as a result of branch detection and subsequent fetching. The number of threads may dictate how far into the program code pre-fetcher unit 12 fetches ahead of ARM processor 14. Too few threads may incur penalties due to unavailability of data in cache 32; too many threads may result in redundant flash reads. Thread register 38 may include a field 92 to indicate the thread type, a field 94 to indicate number of entries corresponding to each thread type, and an optional field 96 to indicate the specific hopper (e.g., 74) used in the thread. In some embodiments, thread register 38 can also include optional information, such as status of the branch (e.g., Branch Valid (8-bits), Branch Source Address offset (3-bits), trailer (e.g., Trailer Valid (8-bits)) and number of hoppers used for data loads (8×3-bits).

Thread register 38 may be used to track threads. At least two methods of tracking may be used: simple tracking; and detailed tracking. Simple tracking can reset the tracking information every time ARM processor 14 fetches non-sequentially. A more aggressive version of simple tracking can involve resetting tracking information on every ARM code access. Detailed tracking may use optional information in cache 32 and thread register 38 to avoid resetting thread information frequently. Simple tracking can be expected to work better with fewer wait state flash and slower system clock period. For example, slower clock period enables faster thread building and resetting thread data frequently enables following ARM fetches more closely. On the other hand, detailed tracking can be expected to help systems with faster clock and more flash wait states by preserving thread information longer. Faster clocks can delay performing branch detection on flash read data or hopper data being delivered to ARM processor 14 resulting in slower thread building

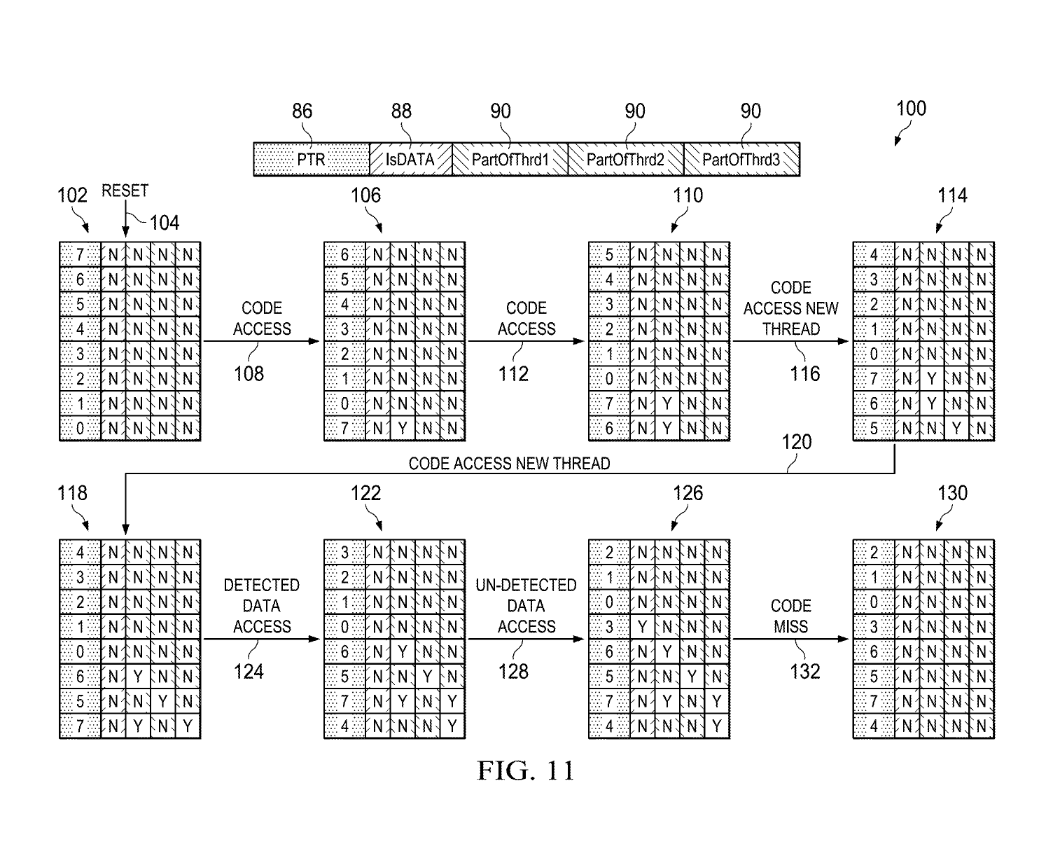

Turning to FIG. 11, FIG. 11 is a simplified block diagram illustrating example details associated with certain operations 100 of hopper pointer array 36 according to embodiments of system 10. Assume, merely for example purposes, and not as a limitation that hopper pointer array 36 includes 8 pointer units pointing to a corresponding hopper in cache 32. Hopper ID field 86 indicates the pointer (e.g., hopper) number (e.g., 0, 1, 2 . . . 7); access identification field 88 indicates whether the corresponding access is instruction or data; and thread identification fields 90 indicate the thread number. Event 102 indicates a reset 104 leading to an initial state of hopper pointer array 36, wherein each field has default values (e.g., N in field 88 indicates no data access; N in fields 90 indicates no threads created in respective cell of the field). Event 106 indicates a code access 108 leading to generation of thread 1 (indicated by a Y in a first cell of field 90 corresponding to hopper ID 7). Hopper ID 7 may be used to hold the flash data. The selection of a specific hopper may be based on various suitable schemes, such as LRU.

Event 110 indicates another code access 112 that fetches the next flash line and loads it into the next available hopper (e.g., hopper ID 6). The fetch may be a sequential fetch and belong to thread 1. At event 114, a branch detector may detect a branch either in hopper ID 7 (hopper 6 being a trailer) or hopper ID 6 (no trailer fetch required). The branch target may be fetched and the read data may be loaded into the next subsequently available hopper (e.g., hopper ID 5), creating thread 2 (and populating a second cell of field 90). At event 118, a branch may be detected in hopper ID 5 during code access 120. A trailer fetch may not be required. The branch target may be found in hopper ID 7 and no flash read may be performed, creating thread 3 corresponding to hopper ID 7 (and populating the third cell in field 90).

At event 122, a data access 124 may be detected in hopper ID 7. A subsequently available hopper (e.g., hopper ID 4) may be used to load the data from the resulting flash read. The data access may be considered a part of thread 3. At event 126, an undetected data access 128 may lead to a flash read. A subsequently available hopper (e.g., hopper ID 3) may be used to store the data according to a modified LRU scheme, wherein hopper ID 3 may not be considered the least recently used as the likelihood of reusing the data hopper is less than for an instruction hopper. At event 130, a code miss may occur. Substantially all threads may be reset. The LRU status may remain unaltered and data in hoppers may be maintained. The number of entries in thread registers may be reset to zero.

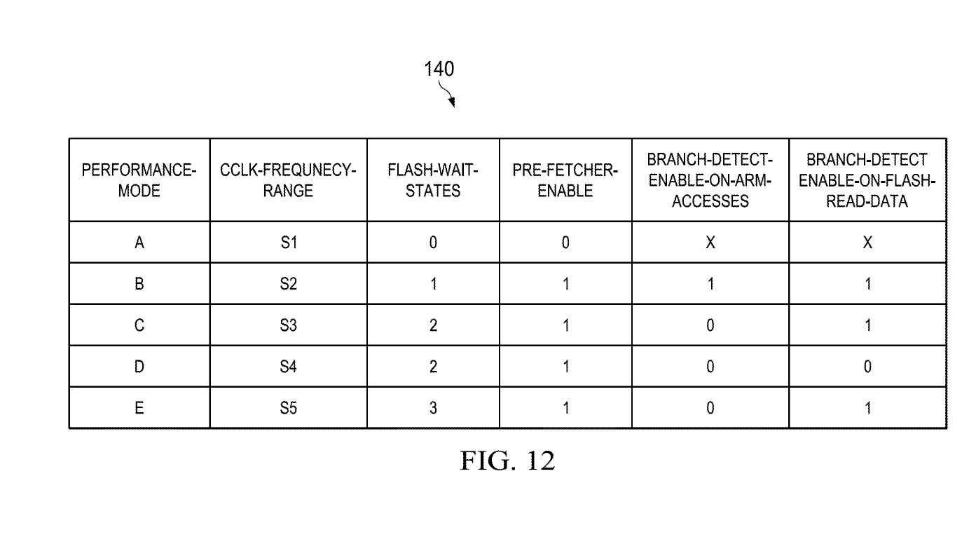

Turning to FIG. 12, FIG. 12 is a simplified block diagram illustrating various example performance modes 140 of pre-fetch unit 12 according to embodiments of system 10. Various embodiments of system 10 can also provide a programmable (e.g., tunable) set of controls that a programmer can modify as appropriate for various applications. Changes in flash wait states (e.g., flash-to-core clock ratio) and in other latencies in the system can be accommodated by engaging or disabling elements of the pre-fetch acceleration operations for optimum performance.

In some embodiments, pre-fetch unit 12 can operate in any one of five performance modes (e.g., A, B, C, D, E, F) as indicated by example performance modes 140. Performance modes may vary with a number of core-clock wait states in each flash access, or with limiting clock frequencies supported by the set of branch detection and prediction hardware enabled in specific modes. For example, in performance mode A corresponding to a core clock (CCLK) range of S1 (e.g., determined from experiments, or otherwise), there are 0 flash states; pre-fetch unit 12 is not enabled; and no branch detection may not be available on ARM accesses and flash read data. In performance mode B corresponding to the CCLK range of S2, there is 1 flash state; pre-fetch unit 12 is enabled; and branch detection is enabled on ARM accesses and flash read data. In performance mode C corresponding to the CCLK range of S3, there are 2 flash states; pre-fetch unit 12 is enabled; and branch detection is not enabled on ARM accesses, whereas branch detection is enabled on flash read data. In performance mode D corresponding to the CCLK range of S4, there are 2 flash states; pre-fetch unit 12 is enabled; and branch detection is not enabled on ARM accesses and flash read data. In performance mode E corresponding to the CCLK range of S5, there are 3 flash states; pre-fetch unit 12 is enabled; and branch detection is not enabled on ARM accesses, whereas branch detection is enabled on flash read data. Note that the CCLK ranges and corresponding settings of pre-fetch unit 12 may be tentative and subject to change based on particular needs.

In a specific example embodiment, the flash overhead percentage may be 10% (flash cycles/SRAM cycles −1) when using settings appropriate for 200 MHz operation (e.g., to allow a fallback position in case flash 22 runs at a 3:1 ratio to a 150 MHz core.). The performance modes suitable to facilitate meeting the overhead percentage goal may be used. In some embodiments, for example, wherein pre-fetch unit 12 is implemented for use in 150 MHz systems, at least one of performance modes B or C may be used. 8 hoppers with basic prediction, and additional features such as prediction of memory data loads (e.g., DCODE accesses), call return snooper on system bus 30, and trailer detection may be implemented. In some embodiments, flash 22 may be implemented as two 512 KB units, which populate the address map as two contiguous 512 KB blocks, with access time of 10 ns, cycle time of 12.5 ns, and setup time for address to SE (CLK) being 0.3 ns.

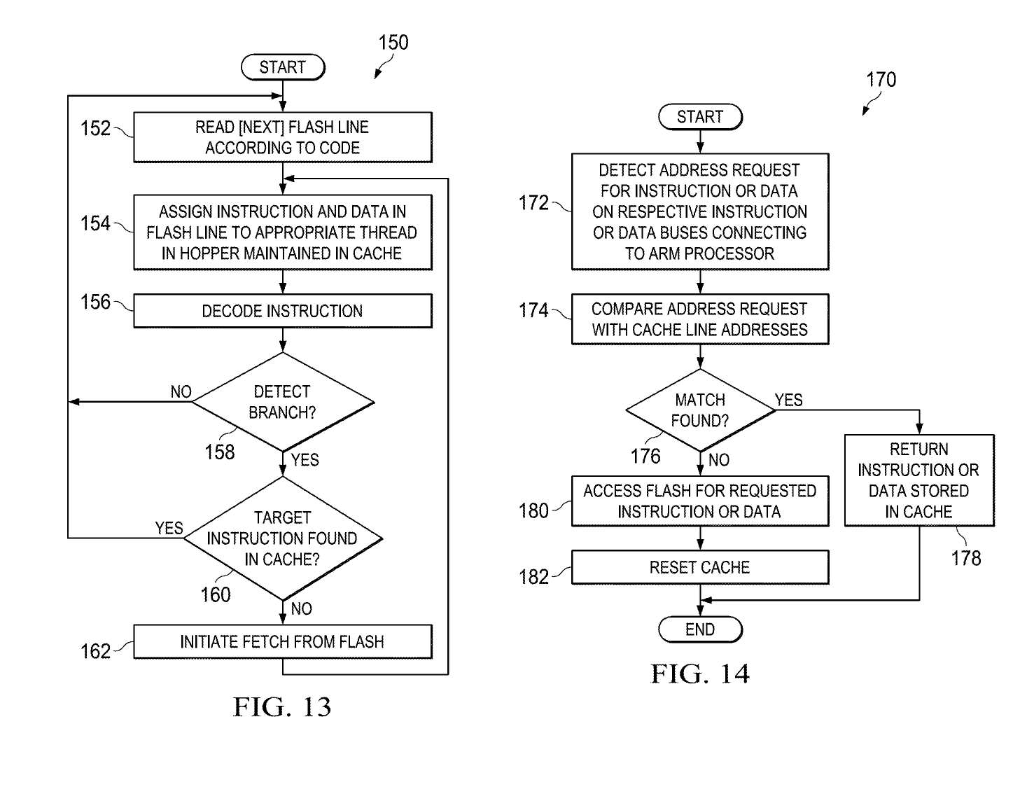

Turning to FIG. 13, FIG. 13 is a simplified flow diagram illustrating example operations 150 that may be associated with an embodiment of system 10. After initializing cache 32, including hoppers therein, at 152, a flash line may be read according to the program code. At 154, the instruction and data encountered in the flash line may be assigned to an appropriate thread in the hopper maintained in cache 32. At 156, the instruction may be decoded. At 158, a determination may be made whether a branch has been detected. If not, the operations may loop back to 152, at which a next flash line according to the executing program code maybe read. If a branch has been detected at 158, at 160, a further determination may be made whether the target instruction is found in cache 32. If the target instruction is found in cache 32, the operations may loop back to 142, and the next flash line according to the program code may be read.

If the target instruction is not found in cache 32, at 162, a fetch may be initiated from flash 22 for the appropriate target address to build and maintain predicted threads of instructions most likely to be executed by ARM processor 14. The fetch may be initiated in some embodiments to build a predetermined number of instruction threads, which may represent a groups of instructions likely (e.g., predicted) to be executed by ARM processor 14 in sequence. The threads may be maintained (e.g., adjusted in size, removed and rebuilt) based on sequential or non-sequential nature of ARM processor 14 fetches, instructions contained in the threads and optionally other branch status hints from ARM processor 14. The process may attempt to maximize a probability of populating cache 32 with instructions more likely to be executed in the near future. The operations may loop back to 154, and continue thereafter. Thus, at any specific instant, cache 32 may be populated with instructions and data accessed from flash 22 and most likely to be requested by ARM processor 14 in the near future during execution of the program code.

Turning to FIG. 14, FIG. 14 is a simplified flow diagram illustrating example operations 170 that may be associated with an embodiment of system 10. At 172, pre-fetch unit 12 may detect an address request for instruction or data on respective instruction or data buses (ICODE bus 26 or DCODE bus 28) connecting to ARM processor 14. At 174, address compare modules 40 may compare address requests with cache line addresses (e.g., information stored in threads in hoppers in cache 32). At 176, a determination may be made whether a match is found. If a match is found, at 178, the corresponding instruction or data stored in cache 32 may be returned to ARM processor 14. If a match is not found (e.g., code miss), at 180, flash 22 may be accessed for the requested instruction or data. In many embodiments, cache 32 may be reset upon a code miss at 182. All threads may be reset. The LRU status may remain unaltered and data in hoppers may be maintained. The number of entries in thread registers may be reset to zero.

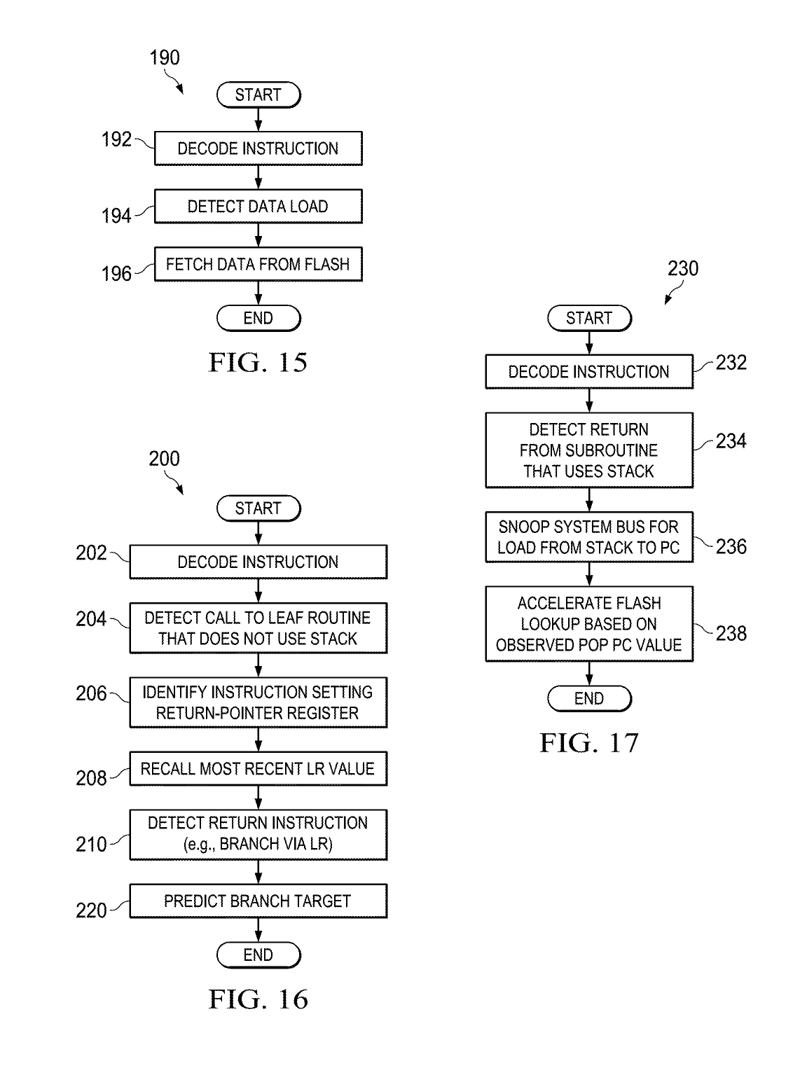

Turning to FIG. 15, FIG. 15 is a simplified flow diagram illustrating example operations 190 that may be associated with an embodiment of system 10. At 192, prediction engine 34 may decode an instruction accessed from flash 22. At 194, prediction engine 34 may detect a data load. At 196, prediction engine 34 may initiate a fetch from flash 22 of the particular data at the specified address and cause the data to be stored in cache 32.

Turning to FIG. 16, FIG. 16 is a simplified flow diagram illustrating example operations 200 that may be associated with an embodiment of system 10. At 202, prediction engine 34 may decode an instruction accessed from flash 22. At 204, prediction engine 34 may detect a call from a leaf routine that does not use the stack. At 206, prediction engine 34 may identify the instruction setting the return pointer register (e.g., LR). At 208, prediction engine 34 may recall the most recent LR value. At 210, prediction engine 34 may detect the return instruction (e.g., branch via LR). At 220, prediction engine 34 may predict the branch target (e.g., based on the LR value, etc.).

Turning to FIG. 17, FIG. 17 is a simplified flow diagram illustrating example operations 230 that may be associated with an embodiment of system 10. At 232, prediction engine 34 may decode an instruction accessed from flash 22. At 234, prediction engine 34 may detect a return from a subroutine that uses the stack. At 236, prediction engine 34 may snoop system bus 30 for load from the stack to PC. At 238, prediction engine 34 may accelerate flash lookup based on the observed POP{ . . . ,PC} value.

Although the discussions herein have referred to an ARM processor, the circuit components, including pre-fetch unit 12 may be implemented in any device, chip, or system wherein a processor, not necessarily an ARM processor, accesses instructions and data from a secondary memory element, such as a flash.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In the discussions of the embodiments above, circuit components, such as capacitors, clocks, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic chips, hardware, software, etc. offer an equally viable option for implementing the teachings of the present disclosure.

In one example embodiment, any number of electrical circuits of the FIGURES may be implemented on a board of an associated electronic chip. The board can be a general circuit board that can hold various components of the internal electronic system of the electronic chip and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and other peripheral chips may be attached to the board as plug-in cards, via cables, or integrated into the board itself.

In another example embodiment, the electrical circuits of the FIGURES may be implemented as stand-alone modules (e.g., a chip with associated components and circuitry configured to perform a specific application or function) or implemented as plug-in modules into application specific hardware of electronic chips. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the functionalities as described herein may be implemented in one or more silicon cores in Application Specific Integrated Circuits (ASICs), Field Programmable Gate Arrays (FPGAs), and other semiconductor chips. In various other embodiments, the functionalities described herein may be implemented in emulation form as software or firmware running within one or more configurable (e.g., programmable) elements arranged in a structure that supports these functions.

It is also imperative to note that all of the specifications, dimensions, and relationships outlined herein (e.g., the number of components, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular component arrangements. Various modifications and changes may be made to such embodiments without departing from the scope of the appended claims. The description and drawings are, accordingly, to be regarded in an illustrative rather than in a restrictive sense.

Note that the activities discussed above with reference to the FIGURES are applicable to any integrated circuits that involve signal processing, particularly those that rely on synchronization signals to execute specialized software programs, or algorithms, some of which may be associated with processing digitized real-time data. Certain embodiments can relate to multi-DSP signal processing, floating point processing, signal/control processing, fixed-function processing, microcontroller applications, etc. In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems.

Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can apply the functionalities described herein in high-precision data conversion products in battery monitoring, control systems, reporting controls, maintenance activities, etc.

In yet other example scenarios, the teachings of the present disclosure can be applicable in the industrial markets that include process control systems that help drive productivity, energy efficiency, and reliability. In consumer applications, the teachings of the electrical circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media chip). Hence, such technologies could readily part of smartphones, tablets, security systems, PCs, gaming technologies, virtual reality, simulation training, etc.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES, EXAMPLES, AND IMPLEMENTATIONS

Note that all optional features of the apparatus described above may also be implemented with respect to the method or process described herein and specifics in the examples may be used anywhere in one or more embodiments. In a first example, a system is provided (that can include any suitable circuitry, dividers, capacitors, resistors, inductors, ADCs, DFFs, logic gates, software, hardware, links, etc.) that can be part of any type of electronic device (e.g., computer), which can further include a circuit board coupled to a plurality of electronic components. The system can include means for pre-fetching instructions from a flash to an ARM processor; means for reading a line of program code from the flash, each line in the flash comprising at least one of instructions and data; means for assigning the instructions and data to a thread in a hopper maintained in a cache, each thread comprising instructions to be executed sequentially by the ARM processor, a plurality of hoppers being maintained in the cache; means for decoding the instructions to detect branches, a branch instruction initiating a new thread, the branch instruction being treated as a last instruction in a current thread, a target instruction at a branch target address being treated as a first instruction in the new thread; and means for initiating a fetch from the flash if the target instruction is not found in one of the hoppers.

The system can also include means for comparing address requests for instructions and data with cache line addresses, the instructions and data being accessed on respective instruction and data buses connecting to the ARM processor; means for returning instructions and data stored in the hoppers if a match is found; and means for accessing the flash if the match is not found. The system can also include means for snooping a system bus connecting to the ARM processor when an instruction to load to PC is encountered for a burst read associated with an instruction to load to PC, a last read data being used to pre-fetch a target address of a branch instruction before the branch instruction is encountered in a next instruction cycle.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A circuit comprising a pre-fetch unit configured to pre-fetch instructions and data from a flash used by a microprocessor and decode the instructions and data without storing and accessing an address history, wherein the pre-fetch unit is aware of the microprocessor's instruction set, wherein the pre-fetch unit performs parallel direct decode of each instruction accessed from the flash.

2. The circuit of claim 1, wherein the pre-fetch unit implements branch decode and detection, literal load decode and detection, subroutine return address modeling and snooping, and thread management.

3. The circuit of claim 1, wherein the pre-fetch unit is connected to the microprocessor through separate buses for instructions and data, wherein a separate system bus is used to snoop a stack of the microprocessor.

4. The circuit of claim 1, wherein the pre-fetch unit fetches a line of program code from the flash, wherein before the microprocessor accesses the fetched line, the pre-fetch unit decodes at least a portion of all possible instruction footprints in the line to detect a branch instruction.

5. The circuit of claim 1, wherein the pre-fetch unit detects calls and returns to leaf routines that do not use a stack in the microprocessor, wherein the pre-fetch unit identifies an instruction that sets a return-pointer to a link register (LR) and recalls a most recent LR value, wherein the pre-fetch unit detects a return instruction and predicts a branch target based on the most recent LR value.

6. The circuit of claim 1, wherein the pre-fetch unit accelerates general calls and returns to leaf routines that use a stack in the microprocessor by detecting a certain class of instructions, snooping a system data bus for loads from the stack to a program counter (PC), and accelerating a flash lookup based on the observed loads from the stack to the PC before the microprocessor presents a fetch to a new PC.

7. The circuit of claim 1, wherein relative branches and branches with indirect addressing are decoded and accelerated, wherein automatic loop branches with at least one of relative loop start addresses, relative loop end addresses and loop counts are decoded and accelerated.

8. The circuit of claim 1, wherein the pre-fetch unit is configured to be enabled in one of a plurality of performance modes, wherein each performance mode accommodates changes at least in flash wait states by engaging or disengaging elements of a pre-fetch acceleration.

9. The circuit of claim 8, wherein elements of the pre-fetch acceleration include branch detection on microprocessor accesses to flash data and branch detection on data accessed by the pre-fetch unit from the flash.

10. The circuit of claim 1, wherein the pre-fetch unit comprises:
a cache configured to store instructions and data retrieved from the flash as one or more threads in a plurality of hoppers, wherein each line in the cache comprises a single hopper;
a prediction engine configured to decode the instructions; and
control structures configured to track and maintain the one or more threads in the cache.

11. The circuit of claim 10, wherein each thread comprises instructions to be executed sequentially by the microprocessor, wherein a branch instruction initiates a new thread, wherein the branch instruction is treated as a last instruction in a current thread, wherein an instruction at a branch target address is treated as a first instruction in the new thread.

12. The circuit of claim 10, wherein a least recently used (LRU) scheme is implemented to select a hopper for a next flash read, wherein a modified LRU scheme is implemented to select a hopper for an undetected data load.

13. The circuit of claim 10, wherein a branch detector in the prediction engine decodes the threads in the hoppers, detects branches in the threads, determines a target address of a target instruction in the threads, and initiates a fetch from the flash if the target instruction is not found in one of the hoppers in the cache, wherein predicted threads of instructions most likely to be executed by the microprocessor are built and maintained in the cache.

14. The circuit of claim 10, wherein each hopper includes hopper data equivalent to a flash read data size, a fetch address corresponding to the hopper data, a status bit representing a state of the data, and a type bit representing a type of access of the data, wherein each hopper is referenced by an identifier (ID).

15. The circuit of claim 10, wherein the control structures comprise:
a hopper pointer array comprising hopper IDs sorted by their retrieval status and comprising thread information; and
a thread register to track the threads, wherein the thread register indicates a thread type and number of threads fetched ahead of the microprocessor.

16. The circuit of claim 10, wherein substantially each access to the flash appearing on instruction and data buses connecting the microprocessor and the pre-fetch unit is looked up in the hoppers, wherein a hit results in the instruction or data being returned from the hoppers, wherein a miss results in an access being made to the flash.

17. A method for pre-fetching instructions from a flash to a microprocessor comprising:
reading a line of program code from the flash, wherein each line in the flash comprises at least one of instructions and data;
assigning the at least one of instructions and data to a thread in a hopper maintained in a cache, wherein each thread comprises instructions to be executed sequentially by the microprocessor, wherein a plurality of hoppers are maintained in the cache;
decoding the instructions to detect branches without storing and accessing an address history, wherein a branch instruction initiates a new thread, wherein the branch instruction is treated as a last instruction in a current thread, wherein a target instruction at a branch target address is treated as a first instruction in the new thread; and
initiating a fetch from the flash if the target instruction is not found in one of the hoppers.

18. The method of claim 17, further comprising,
comparing address requests for instructions and data with cache line addresses, wherein the instructions and data are accessed on respective instruction and data buses connecting to the microprocessor;
returning instructions and data stored in the hoppers if a match is found; and
accessing the flash if the match is not found.

19. The method of claim 17, wherein relative branches and branches with indirect addressing are decoded and accelerated, wherein automatic loop branches with at least one of relative loop start addresses, relative loop end addresses and loop counts are decoded and accelerated.

20. The method of claim 17, wherein when an instruction to load to PC is encountered, a system bus is snooped for a burst read associated with the instruction, wherein a last read data is used to pre-fetch a target address of a branch instruction before the branch instruction is encountered in a next instruction cycle.
